(19) United States
(12) Patent Application Publication
(10) Pub. No.: US 2006/0008252 A1
(43) Pub. Date: Jan. 12, 2006

(54) Apparatus and method for changing reproducing mode of audio file

(75) Inventor: Ji-Woon Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/154,524

(22) Filed: Jun. 17, 2005

(30) Foreign Application Priority Data
Jul. 8, 2004 (KR) 2004-52900

(51) Int. Cl. H04N 5/781

(52) U.S. Cl. 386/96; 386/125

(57) ABSTRACT

An apparatus and a method for reproducing an audio file are provided. When an initial reproducing mode does not satisfying a user's listening taste, a modified reproducing mode can be established to satisfy the user's listening taste. To modify the reproducing mode, a user modifies a reproducing mode for distinguished from the initial mode reproducing the audio file and modified reproducing mode information is stored. The audio file is reproduced based on one of the initial reproducing mode and the modified reproducing mode.

### CROSS-REFERENCE TO RELATED APPLICATIONS

This application claims the benefit under 35 U.S.C. §119(a) of Korean Patent Application No. 2004-52900, entitled “APPARATUS AND METHOD FOR CHANGING REPRODUCING MODE OF AUDIO FILE” filed on Jul. 8, 2004, in the Korean Intellectual Property Office, the entire disclosure of which is hereby incorporated by reference.

### BACKGROUND OF THE INVENTION

1. Field of the Invention

The present invention relates to an apparatus and a method for reproducing a digital audio file. More particularly, the present invention relates to an apparatus and a method for setting a different reproducing mode of a digital audio file according to a user's listening taste.

2. Description of the Related Art

The performance of digital audio devices has developed along with developments in digital technology. Generally the digital audio device is a device for reproducing an audio file. Also, the digital audio device converts analog services, such as voices, into digital audio files and stores the converted audio files. Generally, users have their own listening tastes and the digital audio device comprises various reproducing modes for satisfying the user's various listening tastes.

FIG. 1 is a flowchart illustrating a conventional method for reproducing an audio file. As shown in FIG. 1, a digital audio device reproduces the audio file based on an initial reproducing mode at step S100. The initial reproducing mode is a mode initially established for reproducing the audio file. The user of the digital audio device activates a key button equipped in the digital audio device or uses a remote controller of the digital audio device to reproduce the audio file.

The digital audio device determines whether the user requests to change the reproducing mode at step S102. The user generally wants to reproduce the audio file based on a reproducing mode satisfying the user's listening taste. Accordingly, if the initial reproducing mode is not satisfied by the user, the user requests to change the reproducing mode. That is, if the user requests to change the reproducing mode at step S102, the reproducing mode is changed at step S104. If not, the digital audio device continuously reproduces the audio file based on the initial reproducing mode and the method for reproducing the audio file ends at step S108 after reproducing the audio file.

As described above, if the user requests to change the reproducing mode at step S102, the digital audio device changes the initial reproducing mode at step S104. After changing the reproducing mode, the digital audio device reproduces the audio file according to the changed reproducing mode at step S106. By performing the above mentioned steps, the user reproduces the audio file and listens the reproduced audio file.

If audio files stored in a storing unit of the digital audio device are reproduced with different initial reproducing modes and the user wants to listen to the stored audio files based on user's listening taste, the user must repeatedly perform the above mentioned steps for establishing the reproducing modes of audio files stored in the storing unit.

### SUMMARY OF THE INVENTION

Accordingly, the present inventive concept has been made to solve the above-mentioned problems, and an aspect of the present inventive concept is to provide an apparatus and a method for reproducing an audio file based on a user's listening taste.

Another aspect of the present inventive concept is to provide an apparatus and a method for reducing unnecessary key operations when a stored audio file in a storing unit is reproduced.

Yet another aspect of the present inventive concept is to provide an apparatus and a method for reducing a time for spending to reproduce an audio file by reducing the unnecessary key operations.

In accordance with an aspect of the present invention, a method for reproducing an audio file is provided. The method comprises the steps of a) setting a modified reproducing mode distinguished from an initial reproducing mode for reproducing audio file data based on initial reproducing information, b) storing modified reproducing mode information received after setting reproducing mode information of the modified reproducing mode, and c) reproducing the audio file data according to the modified reproducing mode.

The reproducing mode information may comprise information regarding volume, genre and equalizer settings for reproducing the audio file data.

The reproducing mode information may be stored in a predetermined region of metadata tag for the audio file data, such as, for example, an identification three (ID3) tag of an moving pictures experts group (MPEG) audio layer 3 (MP3) file.

An audio file comprises the reproducing mode information and the audio file data, and the reproducing mode information is preferably located in a front part of the audio file data or a rear part of the audio file data.

The audio file data may be reproduced based on the initial reproducing mode, when the modified reproducing mode is not stored.

In accordance with another aspect of the present inventive concept, an audio reproducing device is provided. The devise comprises an input unit for receiving reproducing mode information that is distinguishable from initial reproducing mode information for setting an initial reproducing mode that reproduces audio file data based on the initial reproducing information, a controller for setting the reproducing mode information input from the input unit; a storing unit for storing a modified reproducing mode set with the reproducing mode information, and a decoding unit for decoding the audio file data by using stored reproducing mode information according to a control of the controller.

The audio reproducing device preferably comprises an encoding unit for encoding the modified reproducing mode information input from the controller and transmitting the modified reproducing mode information to the storing unit, and a displaying unit for displaying information input from the input unit and a state of the audio reproducing device.

### BRIEF DESCRIPTION OF THE DRAWINGS

The above aspects and features of the present invention will be more apparent by describing exemplary embodiments of the present invention with reference to the accompanying drawings, in which:

FIG. 1 is a flowchart illustrating a conventional method for reproducing an audio file;

FIG. 2 is a flowchart illustrating steps for encoding reproducing mode information of audio file data in accordance with an exemplary embodiment of the present invention;

FIG. 3 is a diagram illustrating an audio file structure in accordance with an exemplary embodiment of the present invention;

FIG. 4 is a flowchart illustrating steps for decoding audio file data based on reproducing mode information in accordance with an exemplary embodiment of the present invention; and

FIG. 5 is a diagram illustrating a digital audio device in accordance with an exemplary embodiment of the present invention.

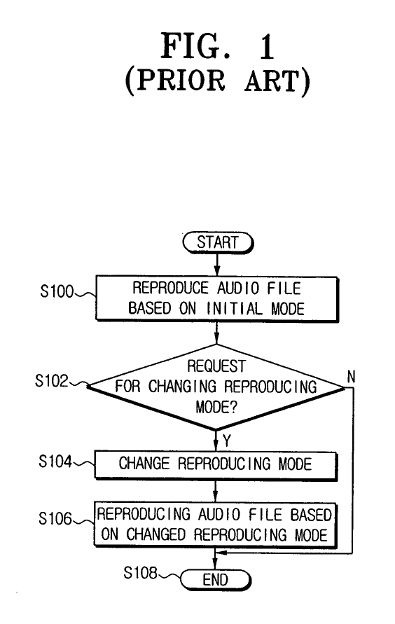

Throughout the drawings, it should be noted that like reference numbers are used to depict the same or similar elements, features and structures.

### DETAILED DESCRIPTION OF EXEMPLARY EMBODIMENTS

The exemplary embodiments of the present invention will be described in greater detail with reference to the accompanying drawings.

The matters defined in the description such as a detailed construction and elements are exemplary. Thus, it is apparent that the present invention can be performed without those defined matters. Also, descriptions of well-known functions or constructions are omitted for clarity and conciseness.

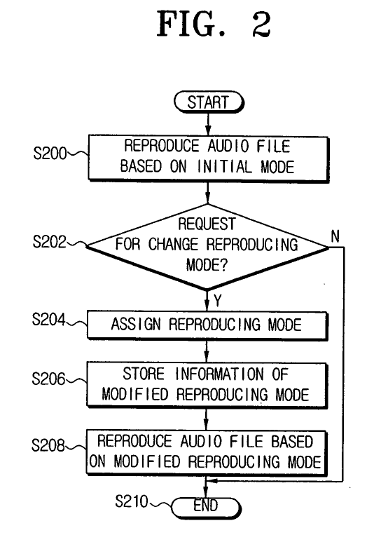

FIG. 2 is a flowchart illustrating steps for encoding information of a modified reproducing mode for reproducing an audio file data in accordance with an exemplary embodiment of the present invention. Hereinafter, the steps for encoding information of a modified reproducing mode are explained in detail by referring to the FIG. 2.

At step S200, the digital audio device reproduces an audio file based on an initial reproducing mode. The user of the digital audio device typically activates a key button equipped in the digital audio device or uses a remote controller of the digital audio device to reproduce the audio file.

At step S202, the digital audio device determines whether a user requests to change the initial reproducing mode. The user of the digital audio device generally wants to reproduce the audio file based on a reproducing mode satisfying the user's listening taste. Accordingly, if the initial reproducing mode does not satisfy the user's listening taste, the user requests to change the initial reproducing mode. If the user requests to change the reproducing mode at step S202, the reproducing mode is modified according to the user's request at step S204. Otherwise, the audio file is continuously reproduced based on the initial reproducing mode and the method for reproducing the audio file is terminated at step S210 after reproducing the audio file.

As described above, if the user requests to change the initial reproducing mode at step S202, the digital audio device assigns a predetermined reproducing mode for reproducing the audio file at step S204. The assigned reproducing mode is a modified reproducing mode. The reproducing mode is constructed with a plurality of elements and the elements assignable by a user will be explained in greater detail below. The digital audio device stores information of the modified reproducing mode at step S206. The digital audio device continues to reproduce the audio file data based on the modified reproducing mode at step S208.

Hereinafter, the elements for constructing the reproducing mode information are explained. Exemplary elements are information to set volume, genre, and equalizer settings. The volume represents loudness for reproducing the audio file. The genre represents a taste of reproducing the audio file and examples include classic, rock or jazz. Also, by setting the equalizer, tone of the audio file is corrected or noises of the audio file are eliminated according to the user's taste.

Hereinafter, steps for changing the elements of the reproducing mode are explained in detail. The user may change the volume set within the initial reproducing mode. That is, if the volume set with the initial reproducing mode is too low, the user changes the volume by modifying information of the volume set within the initial reproducing mode. If the user wants to reproduce an audio file set as “classic” when the audio file set as “jazz”, the user changes the genre of the reproducing mode to “classic” for reproducing the audio file classically.

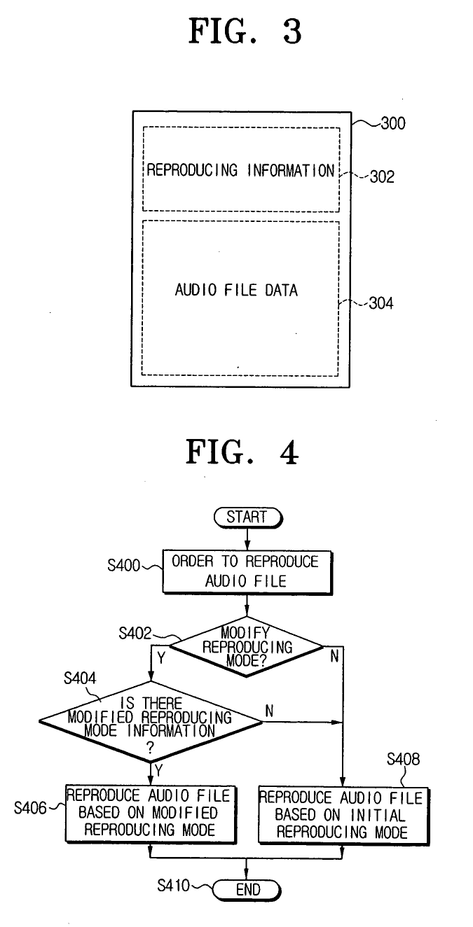

FIG. 3 is a diagram illustrating an audio file structure 300 according to an exemplary embodiment of the present invention. As shown in FIG. 3, the audio file 300 comprises reproducing information 302 and audio file data 304. The reproducing information 302 comprises initial reproducing information and modified reproducing information.

There may be various ways to store the modified reproducing information in the storing unit. In an exemplary embodiment of the present invention, a metadata tag such as an identification 3 version 2 (ID3v2) tag is used for storing the modified reproducing information. The ID3v2 comprises frame identifications such as ‘X’, ‘Y’, and ‘Z’. Accordingly, the user uses one of ‘X’, ‘Y’, and ‘Z’ to encode the modified reproducing information.

Generally, the volume may be set from 0% to 100%. When the user wants to set the volume to 50% for reproducing the audio file, it can be expressed as a hexadecimal (HEX) code such as the following.
‘5A 56 4F 4C 00 00 00 04 00 00 00 00 00 32’

The exemplary HEX code comprises 14 bytes and is divided into four parts each of which represents a tag, a size, a flag and information.

Among the 14 bytes of the HEX code, the first 4 bytes of the HEX code (5A 56 4F 4C) represent ‘ZVOL’ where ‘Z’ is a frame identification and ‘VOL’ means the volume. And, next 4 bytes of the HEX code (00 00 00 04) represents a size of information and it means that the size of information is 4 bytes. Also, the next 2 bytes of the HEX code (00 00) represent that a flag is not set. And, the last 4 bytes of the HEX code (00 00 00 32) represent that the volume is set as 50%. As mentioned above, the HEX code represents that the information is construed with 4 bytes. As described above, the modified reproducing mode information is converted to a HEX code and stored in the storing unit.

In an exemplary embodiment of the present invention, the modified reproducing mode information is preferably located in a front part of the audio file data. However, the modified reproducing mode information may be comprised in a rear part of the audio file data or any other suitable location. Also, the user may use other codes to store the modified reproducing information.

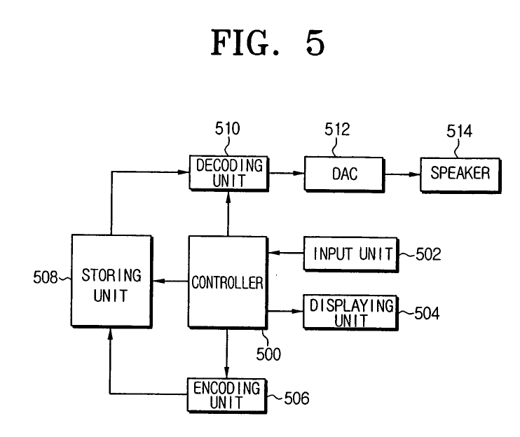

FIG. 4 is a flowchart illustrating steps for decoding audio file data stored in a storing unit in accordance with an exemplary embodiment of the present invention. By referring to FIG. 4, the steps for decoding audio file data stored in a storing unit are explained in detail.

At step S400, the digital audio device receives a command to reproduce the audio file data stored in the storing unit from a user. The user may use a key button or a remote control to generate the command to reproduce the audio file data.

At step S402, the digital audio device selects one of at least two of reproducing modes. The user also uses the key buttons or the remote controller to select one of the reproducing modes. In an exemplary embodiment of the present invention, there is an initial reproducing mode and a modified reproducing mode. If the digital audio device selects a different reproducing mode at step S402, the digital audio device determines whether there is a modified reproducing mode stored in a storing unit at step S404. If the digital audio device selects not to modify the initial reproducing mode, the digital audio device reproduces the audio file based on the initial reproducing mode at step S408.

At step S404, the digital audio device determines whether there is the modified reproducing mode is already stored in the storing unit. If modified reproducing mode is not stored in the storing unit and the user selects to modify the reproducing mode, the audio file can not yet be reproduced according to the user's taste. Therefore, if there is no modified reproducing mode at step S404, the audio file is reproduced based on the initial reproducing mode at step S408. If there is a modified reproducing mode stored in the storing unit, the digital audio device reproduces the audio file based on the modified reproducing mode at step S406.

As mentioned above, the digital audio device reproduces the audio file data by using the modified reproducing mode information as shown in FIG. 4 at step S406 when the modified reproducing mode is stored in the storing unit, and the method for reproducing the audio file ends at step S410 after reproducing the audio file. Also, the digital audio device reproduces the audio file data by using the initial reproducing mode information at step S408 when there is no modified reproducing mode, and the method of FIG. 4 ends at step S410 after reproducing the audio file according to the initial reproducing mode information.

FIG. 4 illustrates steps for reproducing the audio file data by using the modified reproducing mode information or the initial reproducing mode information. However, the user may modify the reproducing mode according to the steps of FIG. 2 during reproducing the audio file according to the steps of FIG. 4.

In FIGS. 2 through 4, the above mentioned steps are performed for each of the audio files. However, a single set of modified reproducing mode information may be implemented to all stored audio files in the storing unit according to a setting of the user.

Also, in the example of FIGS. 2 through 4, a single modified reproducing mode is set to an audio file. However, as will be appreciated by those of ordinary skill in the art two or more modified reproducing modes may also be set to an audio file.

FIG. 5 is a diagram illustrating a digital audio device in accordance with an exemplary embodiment of the present invention. As shown in FIG. 5, the digital audio device comprises a controller 500, an input unit 502, a displaying unit 504, an encoding unit 506, a storing unit 508, a decoding unit 510, a digital/analog converter (DAC) 512 and a speaker 514. Hereinafter, the digital audio device is explained in detail by referring to FIG. 5.

The input unit 502 comprises a key button or a remote controller and receives necessary information from a user. The necessary information comprises reproducing information, modification information and modified reproducing mode information. The reproducing information is information about reproducing audio file data stored in the storing unit. The modification information is information about modifying the reproducing mode.

The displaying unit 504 displays the information received from the input unit 502. Also, the displaying unit 504 displays states of the digital audio device.

The encoding unit 506 encodes the modified reproducing information from the input unit 502 according to a control of the controller 500. Also, the encoding unit 506 encodes necessary information according to the control of the controller 500.

The storing unit 508 receives the encoded information from the encoding unit 506 and stores the received information. The storing unit 508 also stores audio file data, initial reproducing information, modified reproducing mode information and necessary information for operating the digital audio device.

The decoding unit 510 decodes audio file data stored in the storing unit 508 according to a control of the controller 500. The audio file data is decoded by using the initial reproducing mode information or the modified reproducing mode information.

The DAC 512 converts decoded digital data from the decoding unit 510 to analog data. The analog data is transmitted to the speaker 514. The speaker 514 outputs sound based on the waveform.

As mentioned above, embodiments of the present invention establish a reproducing mode of an audio file stored in a storing unit according to a user's listening taste. Accordingly, unnecessary key operations are eliminated by reproducing the audio file according to a stored reproducing mode. Also, unnecessary key operations are reduced by implementing a single set of modified reproducing mode information to all audio files stored in the storing unit.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for reproducing an audio file, the method comprising the steps of:
establishing a modified reproducing mode distinguished from an initial reproducing mode for reproducing an audio file data based on initial reproducing information mode;
storing modified reproducing mode information received after establishing as reproducing mode information the modified reproducing mode; and
reproducing the audio file data according to the modified reproducing mode.

2. The method of claim 1, wherein the reproducing mode information comprises information related to volume, genre and equalizer settings for reproducing the audio file data.

3. The method of claim 2, wherein the reproducing mode information is stored in a predetermined region of a metadata tag.

4. The method of claim 3, wherein the metadata is an identification 3 version 2 (ID3v2) tag.

5. The method of claim 1, wherein an audio file comprises the reproducing mode information and the audio file data, and the reproducing mode information is stored in one of a front part of the audio file data and a rear part of the audio file data.

6. The method of claim 1, wherein the audio file data is reproduced based on the initial reproducing mode, when the modified reproducing mode information is not stored.

7. An audio reproducing device, comprising:
an input unit for receiving reproducing mode information distinguishable from initial reproducing mode information for constructing an initial reproducing mode that reproduces audio file data based on the initial reproducing mode information;
a controller for setting the reproducing mode information input from the input unit;
a storing unit for storing a modified reproducing mode information constructed with the reproducing mode information; and
a decoding unit for decoding the audio file data by using said stored reproducing mode information according to a control of the controller.

8. The audio reproducing device of claim 6, wherein the reproducing mode information comprises information related to volume, genre and equalizer settings for reproducing the audio file data.

9. The audio reproducing device of claim 6, further comprising an encoding unit for encoding the modified reproducing mode information input from the controller and transmitting the modified reproducing mode information to the storing unit.

10. The audio reproducing device of claim 8, further comprising a displaying unit for displaying information input from the input unit and a state of the audio reproducing device.

11. The audio reproducing device of claim 6, wherein the storing unit stores the reproducing mode information in one of a front part of the audio file data and a rear part of the audio file data.

12. The audio reproducing device of claim 6, wherein the controller causes reproduction of the audio file data based on the initial reproducing mode when the modified reproducing mode is not stored.
